(19) United States
(12) Patent Application Publication
(10) Pub. No.: US 2017/0051802 A1
(43) Pub. Date: Feb. 23, 2017

(54) BRAKE FOR VEHICLE

(71) Applicant: HYUNDAI MOBIS CO., LTD., Seoul (KR)

(72) Inventor: Moo Jin CHOI, Yongin-si (KR)

(21) Appl. No.: 15/130,798

(22) Filed: Apr. 15, 2016

(30) Foreign Application Priority Data
Aug. 20, 2015 (KR) 10-2015-0117528

(51) Int. Cl. F16D 65/22; F16D 51/28

(52) U.S. Cl. CPC F16D 65/22; F16D 51/28; F16D 2121/24

(57) ABSTRACT

A brake for a vehicle may include: first and second brake shoes movably coupled to a back plate, and isolated from each other; a wheel cylinder positioned between one end of the first brake shoe and one end of the second brake shoe, and expanding a distance between the end of the first brake shoe and the end of the second brake shoe; and an anchor part positioned between the other end of the first brake shoe and the other end of the second brake shoe, and adjusting a distance between the other end of the first brake shoe and the other end of the second brake shoe.

### CROSS-REFERENCES TO RELATED APPLICATIONS

The present application claims priority to Korean application number 10-2015-0117528, filed on Aug. 20, 2015, which is incorporated by reference in its entirety.

### BACKGROUND

The present disclosure relates to a brake for a vehicle, and more particularly, to a brake for a vehicle, which is mounted in a vehicle so as to generate a braking force.

In general, a brake for a vehicle refers to a device which is used to decelerate or stop a vehicle in operation or to maintain the parked state of a vehicle.

The brake for a vehicle is divided into a drum brake which is pushed against a cylindrical drum so as to generate a braking force and a disk brake which is pushed against a circular disk so as to generate a braking force. In particular, an LIT (Leading Trailing) drum brake has lower braking performance than the disk brake, but can secure a more stable braking force than other types of drum brakes. The L/T drum brake is mostly applied to the rear wheels, in order to perform a normal brake operation and a parking brake operation.

The related technology is disclosed in Korean Patent Laid-open Publication No. 2015-0049725 published on May 8, 2015 and entitled “Parking brake apparatus for automobile”.

### SUMMARY

Embodiments of the present invention are directed to a brake for a vehicle, which is capable of performing a parking brake operation as well as a normal brake operation through a simple structure.

In one embodiment, a brake for a vehicle may include: first and second brake shoes movably coupled to a back plate, and isolated from each other; a wheel cylinder positioned between one end of the first brake shoe and one end of the second brake shoe, and expanding a distance between the end of the first brake shoe and the end of the second brake shoe; and an anchor part positioned between the other end of the first brake shoe and the other end of the second brake shoe, and adjusting a distance between the other end of the first brake shoe and the other end of the second brake shoe.

The anchor part may include: a driving unit coupled to the back plate and generating a driving force; a variable length part having both ends placed against the other end of the first brake shoe and the other end of the second brake shoe, respectively, and adjusting the distance between the other end of the first brake shoe and the other end of the second brake shoe, while the length thereof is varied by the driving unit; and a housing part coupled to the back plate, and housing the variable length part therein.

The variable length part may be slidably coupled to the housing part.

The variable length part may include: a first variable part movably coupled to the housing part, and placed against the other end of the first brake shoe; a second variable part movably coupled to the housing part, and placed against the other end of the second brake shoe; and a variable rotating part positioned between the first and second variable parts, and varying a distance between the first and second variable parts while being rotated by the driving unit engaged with the variable rotating part.

The driving unit may include: a motor for generating a rotational force; and a rotating shaft rotated by the motor coupled thereto and having a worm gear formed on the outer circumferential surface thereof, and the variable rotating part may have a groove formed on the outer circumferential surface thereof so as to be engaged with the worm gear.

The first variable part may include: a first body part slidably coupled to the housing part; a first rotation coupling part positioned at one end of the first body part, and placed against the variable rotating part; and a first shoe coupling part positioned at the other end of the first body part, and placed against the first brake shoe.

The first rotation coupling part may be concavely formed at the end of the first body part, such that the variable rotating part is rotatably fitted to the first rotation coupling part.

The first shoe coupling part may be concavely formed at the other end of the first body part, such that the other end of the first brake shoe is fitted and coupled to the first shoe coupling part.

The first variable part may further include a first bump protruding from the outer circumferential surface of the first body part, and restricting the extent to which the first body part is inserted into the housing part.

The second variable part may include: a second body part slidably coupled to the housing part; a second rotation coupling part positioned at one end of the second body part, and screwed to the variable rotating part; and a second shoe coupling part positioned at the other end of the second body part, and placed against the second brake shoe.

The second rotation coupling part may protrude from the end of the second body part, and be screwed to the variable rotating part through a screw thread formed on the outer circumferential surface thereof.

The second shoe coupling part may be concavely formed at the other end of the second body part, such that the other end of the second brake shoe is fitted and coupled to the second shoe coupling part.

The second variable part may further include a second bump protruding from the outer circumferential surface of the second body part, and restricting the extent to which the second body part is inserted into the housing part.

The variable rotating part may include: a rotating body positioned between the first and second variable parts, and rotated by the driving unit engaged with a gear formed on the circumferential surface thereof in the circumferential direction; a first coupling part which is convexly formed at one end of the rotating body and to which the first variable part is rotatably fitted; and a second coupling part which is concavely formed at the other end of the rotating body and to which the second variable part is screwed.

The housing part may include: an anchor housing to which the variable length part is slidably coupled; and a shoe rotation restriction part which protrudes from both sides of the anchor housing and against which the other end of the first or second brake shoe is pushed according to the rotation of the first or second brake shoe.

### BRIEF DESCRIPTION OF THE DRAWINGS

FIG. 1 is a schematic front view of a brake for a vehicle in accordance with a first embodiment of the present invention.

FIG. 2 is a schematic rear view of the brake for a vehicle in accordance with the first embodiment of the present invention.

FIG. 3 is a schematic perspective view of a driving unit and an anchor part in accordance with the first embodiment of the present invention.

FIG. 4 is a diagram illustrating the anchor part and first and second brake shoes in accordance with the first embodiment of the present invention.

FIG. 5 is a cross-sectional view of the anchor part in accordance with the first embodiment of the present invention.

FIG. 6 is a diagram illustrating a state in which a variable length part is expanded in the anchor part in accordance with the first embodiment of the present invention.

FIG. 7 is a diagram illustrating rotations of a drum and the first and second brake shoes during a parking brake operation of the brake for a vehicle in accordance with the first embodiment of the present invention.

FIG. 8 is a diagram illustrating a state in which the anchor part restricts rotations of the first and second brake shoes in accordance with the first embodiment of the present invention.

FIG. 9 is a diagram illustrating an anchor part in a brake for a vehicle in accordance with a second embodiment of the present invention.

FIG. 10 is a cross-sectional view of the anchor part in the brake for a vehicle in accordance with the second embodiment of the present invention.

FIG. 11 is a diagram illustrating a state in which a variable length part is expanded in the anchor part of the brake for a vehicle in accordance with the second embodiment of the present invention.

FIG. 12 is a diagram illustrating a state in which the anchor part restricts rotations of the first and second brake shoes in accordance with the second embodiment of the present invention.

### DESCRIPTION OF EMBODIMENTS

Embodiments of the invention will hereinafter be described in detail with reference to the accompanying drawings. It should be noted that the drawings are not to precise scale and may be exaggerated in thickness of lines or sizes of components for descriptive convenience and clarity only.

Furthermore, the terms as used herein are defined by taking functions of the invention into account and can be changed according to the custom or intention of users or operators. Therefore, definition of the terms should be made according to the overall disclosures set forth herein.

During normal brake operation of an LIT drum brake, a cylinder rod is pushed by hydraulic pressure applied to a wheel cylinder. Then, a brake shoe placed against the cylinder rod is pushed against the drum while being expanded with an anchor part set to an axis, thereby restricting the rotation of the drum.

During parking brake operation of the L/T drum brake, when power is transmitted through a brake cable, a parking lever is rotated to pressurize a push rod. Then, the brake shoe generates a braking force while being expanded and pressed against the drum by the force of the pressurized push rod to pressurize the brake shoe and a repulsive force caused by the pressurizing force.

The typical L/T drum brake requires a complex structure including the brake cable and the parking lever, in order to perform a parking brake operation. Furthermore, the volume of the typical L/T drum brake needs to be increased in order to secure a sufficient braking force, or the selection width of applicable liners is narrowed. Thus, there is a demand for a structure capable of improving such a problem.

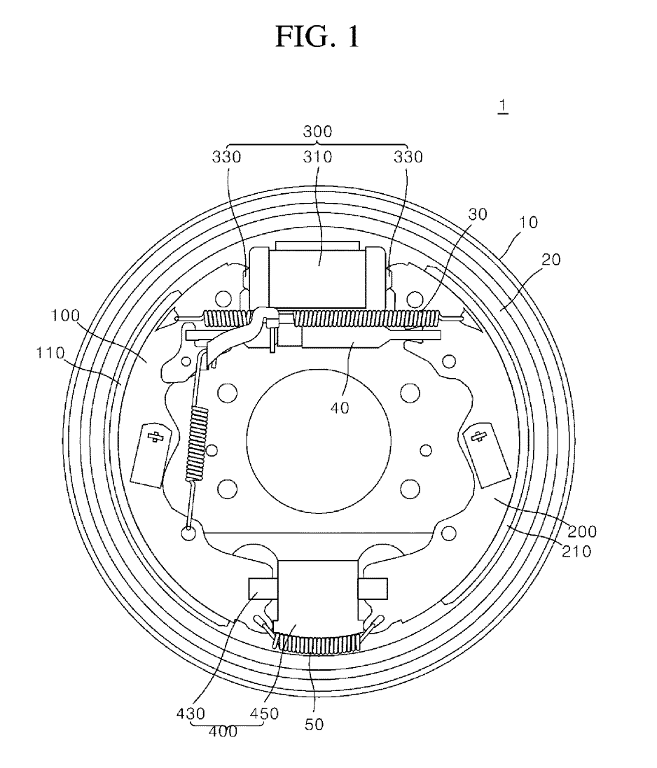

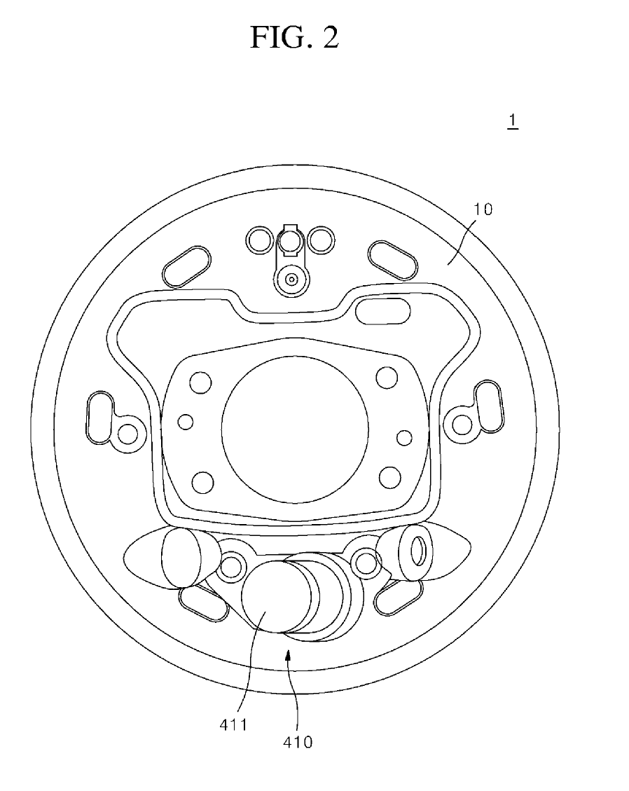

FIG. 1 is a schematic front view of a brake for a vehicle in accordance with a first embodiment of the present invention, and FIG. 2 is a schematic rear view of the brake for a vehicle in accordance with the first embodiment of the present invention.

Referring to FIGS. 1 and 2, the brake 1 for a vehicle in accordance with the first embodiment may include a first brake shoe 100, a second brake shoe 200, a wheel cylinder 300 and an anchor part 400.

The first and second brake shoes 100 and 200 may be movably coupled to a back plate 10 through a pin or clip. In the present embodiment, the first and second brake shoes 100 and 200 may be formed in a circular arc shape which is convex toward the inner surface of the drum 20, and include liners 110 and 210 attached to surfaces facing the drum 20, respectively, in order to increase a frictional force between the drum 20 and the first and second brake shoes 100 and 200.

One ends of the first and second brake shoes 100 and 200 (upper ends in FIG. 1) may be placed against the wheel cylinder 300, and the other ends of the first and second brake shoes 100 and 200 (lower ends in FIG. 1) may be placed against the anchor part 400.

The wheel cylinder 300 may be positioned between the ends of the first and second brake shoes 100 and 200. The wheel cylinder 300 may expand the distance between the ends of the first and second brake shoes 100 and 200, and push the first and second brake shoes 100 and 200 against the drum 20, thereby restricting the rotation of the wheel which is rotated with the drum 20. In the present embodiment, the wheel cylinder 300 may include a cylinder housing 310 and a pair of cylinder rods 330.

The cylinder housing 310 may be coupled to the back plate 10 through bolting or welding. According to a brake pedal operation of a driver, the internal hydraulic pressure of the cylinder housing 310 may be varied to adjust the distance between the ends of the first and second brake shoes 100 and 200. The pair of cylinder rods 330 may be movably installed at both sides of the cylinder housing 310, and placed against the first and second brake shoes 100 and 200, respectively.

The extent to which the pair of cylinder rods 330 protrudes from the cylinder housing 310 may be changed according to the internal hydraulic pressure of the cylinder housing 310. When the internal hydraulic pressure of the cylinder housing 310 is raised, the pair of cylinder rods 330 may be moved to the outside of the cylinder housing 310 (left and right sides in FIG. 1), thereby expanding the distance between the other ends of the first and second brake shoes 100 and 200.

In the present embodiment, the pair of cylinder rods 330 may be installed so as to raise the hydraulic pressure when a user operates a brake pedal. The pair of cylinder rods 330 may expand the distance between the other ends of the first and second brake shoes 100 and 200, and push the first and second brake shoes 100 and 200 against the drum 20, thereby generating a normal braking force of the vehicle.

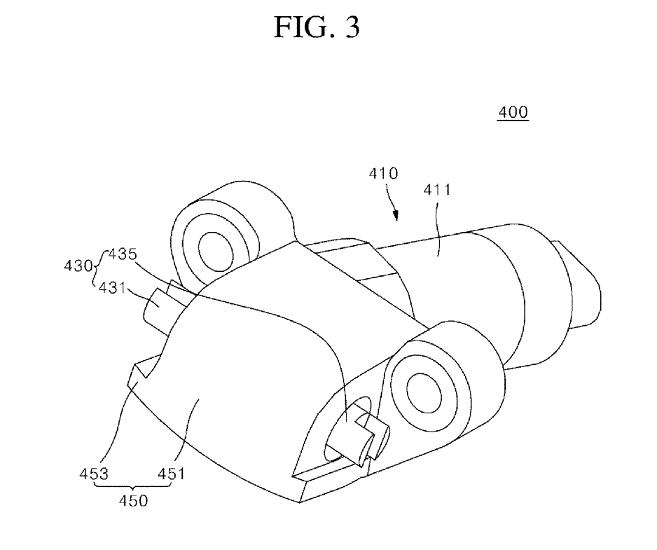

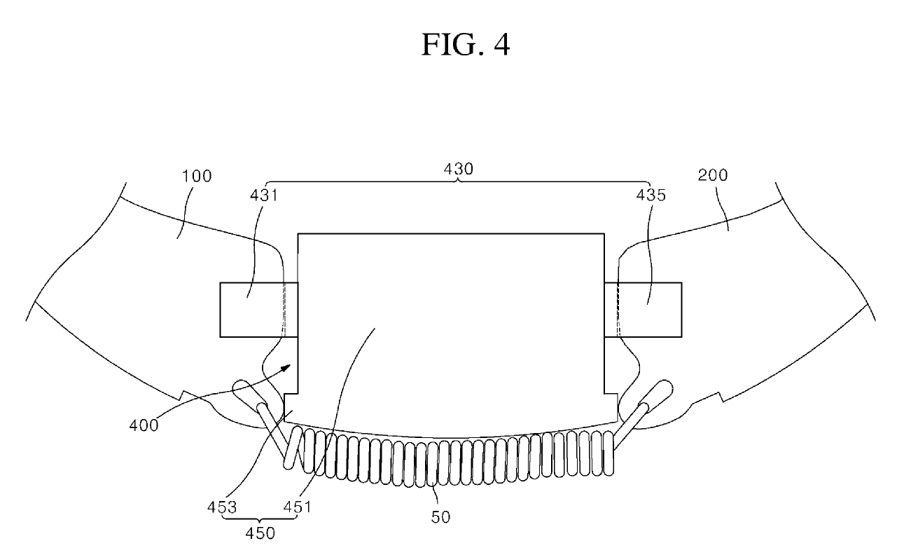

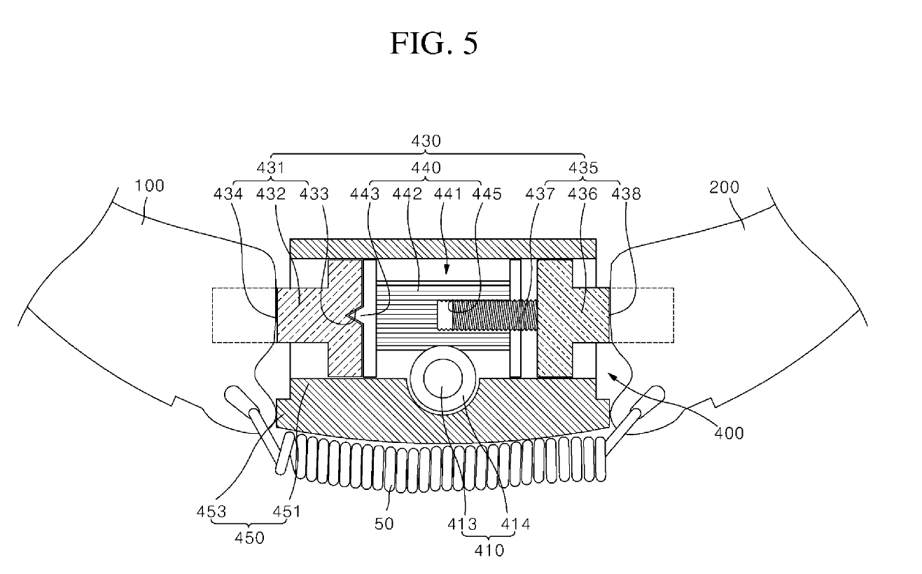

FIG. 3 is a schematic perspective view of a driving unit and the anchor part in accordance with the first embodiment of the present invention, FIG. 4 is a diagram illustrating the anchor part and the first and second brake shoes in accordance with the first embodiment of the present invention, and FIG. 5 is a cross-sectional view of the anchor part in accordance with the first embodiment of the present invention.

Referring to FIGS. 3 to 5, the anchor part 400 may be positioned between the other ends of the first and second brake shoes 100 and 200, restrict the movement of the first and second brake shoes 100 and 200, and expand the distance between the other end parts of the first and second brake shoes 100 and 200. In the present embodiment, the anchor part 400 may include a driving unit 410, a variable length part 430 and a housing part 450.

The driving unit 410 may be coupled to the back plate 10 and generate a driving force. In the present embodiment, the driving unit 410 may include a motor 411 and a rotating shaft 413. When a driver of the vehicle operates a parking brake lever or button, the rotating shaft 413 may be rotated by the motor 411, and transmit a rotational force to the variable length part 430 engaged with a worm gear 414 formed on the rotating shaft 413.

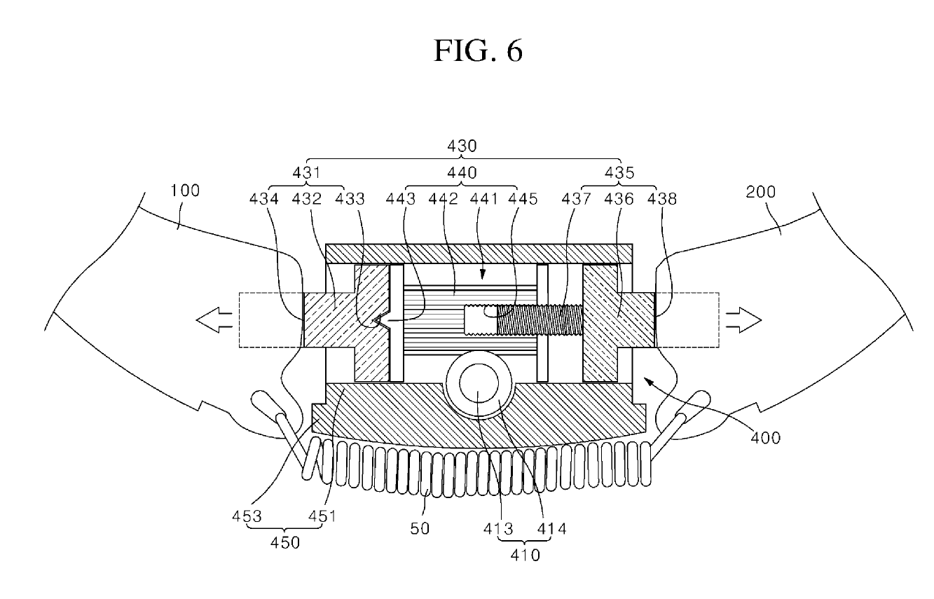

FIG. 5 is a cross-sectional view of the anchor part in accordance with the first embodiment of the present invention, and FIG. 6 is a diagram illustrating a state in which the variable length part is expanded in the anchor part in accordance with the first embodiment of the present invention.

Referring to FIGS. 5 and 6, both ends of the variable length part 430 may be placed against the other ends of the first and second brake shoes 100 and 200 (the lower ends in FIG. 1), respectively, and the length of the variable length part 430 may be varied by a rotational force received from the driving unit 410, thereby adjusting the distance between the other ends of the first and second brake shoes 100 and 200. In the present embodiment, the variable length part 430 may include a first variable part 431, a second variable part 435 and a variable rotating part 440.

The first variable part 431 may be movably coupled to the housing part 450, and placed against the other end of the first brake shoe 100. In the present embodiment, the first variable part 431 may include a first body part 432, a first rotation coupling part 433 and a first shoe coupling part 434.

The first body part 432 may be slidably coupled to the housing part 450. In the present embodiment, the first body part 432 may be inserted into the housing part 450, one end of the first body part 432 may be coupled to the variable rotating part 440 through the first rotation coupling part 433, and the other end of the first body part 432 may protrude to the outside of the housing part 450 so as to be extended toward the first brake shoe 100.

The first rotation coupling part 433 may be positioned at the end of the first body part 432, and placed against the variable rotating part 440. In the present embodiment, the first rotation coupling part 433 may be concavely formed at substantially the center of the surface where the first body part 432 faces the variable rotating part 440, and the variable rotating part 440 may be rotatably inserted into the first rotation coupling part 433.

The first shoe coupling part 434 may be positioned at the other end of the first body part 432, and placed against the first brake shoe 100. In the present embodiment, the first shoe coupling part 434 may be concavely formed at the other end of the first body part 432, and the other end of the first brake shoe 100 may be fitted and coupled to the first shoe coupling part 434.

In the present embodiment, the first body part 432, the first rotation coupling part 433 and the first shoe coupling part 434 may be integrally formed to reduce the number of parts and the number of assembling processes, while improving the durability.

The second variable part 435 may be movably coupled to the housing part 450, placed against the other end of the second brake shoe 200, and screwed to the variable rotating part 440. In the present embodiment, the second variable part 435 may include a second body part 436, a second rotation coupling part 437 and a second shoe coupling part 438.

The second body part 436 may be slidably coupled to the housing part 450, one end of the second body part 436 may be coupled to the variable rotating part 440 through the second rotation coupling part 437, and the other end of the second body part 436 may protrude to the outside of the housing part 450 so as to be extended toward the second brake shoe 200.

The second rotation coupling part 437 may be positioned at one end of the second body part 436, and screwed to the variable rotating part 440. In the present embodiment, the second rotation coupling part 437 may be formed to protrude from the second body part 436, and screwed to the variable rotating part 440 through a screw thread formed on the outer circumference thereof.

According to the extent to which the second rotation coupling part 437 and the variable rotating part 440 are screwed to each other, the entire length of the variable length part 430 may be adjusted. As a result, the distance between the other ends of the first and second brake shoes 100 and 200 placed against the first and second variable parts 431 and 435, respectively, may be adjusted.

The second shoe coupling part 438 may be coupled to the other end of the second body part 436, and placed against the second brake shoe 200. In the present embodiment, the second shoe coupling part 438 may be concavely formed at the other end of the second body part 436, and the other end of the second brake shoe 200 may be fitted and coupled to the second shoe coupling part 438.

In the present embodiment, the second body part 436, the second rotation coupling part 437 and the second shoe coupling part 438 may be integrally formed to reduce the number of parts and the number of assembling processes, while improving the durability.

The variable rotating part 440 may be positioned between the first and second variable parts 431 and 435, and rotated by the driving unit 410 engaged with the variable rotating part 440, thereby changing the distance between the first and second variable parts 431 and 435. In the present embodiment, the variable rotating part 440 may include a rotating body 441, a first coupling part 443 and a second coupling part 445.

The rotating body 441 may be positioned between the first and second variable parts 431 and 435, and rotated by the driving unit 410 engaged with a gear 442 formed on the outer circumferential surface thereof in the circumferential direction.

In the present embodiment, the rotating body 441 may be formed in a cylindrical shape, and slidably installed in the housing part 450. Thus, the variable rotating part 440 may be moved in the longitudinal direction thereof (side-to-side direction of FIG. 5) in a state where the variable rotating part 440 is engaged with the driving unit 410. Simultaneously, the variable rotating part 440 may be rotated by a rotational force received from the driving unit 410.

The first coupling part 443 may be convexly formed at one end of the rotating body 441, and the first variable part 431 may be rotatably fitted to the first coupling part 443. In the present embodiment, the first coupling part 443 may be formed to protrude at substantially the center of the end of the rotating body 441, rotatably fitted to the first rotation coupling part 433, and have a curved surface to prevent friction and noise.

The second coupling part 445 may be concavely formed at the other end of the rotating body 441, and rotated with the rotating body 441 in a state where the second variable part 435 is screwed to the second coupling part 445.

In the present embodiment, when the variable rotating part 440 is rotated by the driving unit 410, the distance between the first and second variable parts 431 and 435 may be adjusted while the variable rotating part 440 and the second variable part 435 are screwed to each other or the coupling therebetween is released.

In particular, when the distance between the first and second variable parts 431 and 435 is expanded, the distance between the other ends of the first and second brake shoes 100 and 200 placed against the first and second variable parts 431 and 435 may be expanded. Then, while the first and second brake shoes 100 and 200 are rotated about the push rod 40 or the wheel cylinder 300, the first and second brake shoes 100 and 200 may be pushed against the internal circumferential surface of the drum 20, thereby generating a braking force.

The housing part 450 may be coupled to the back plate 10 through welding or bolting, and the variable length part 430 may be slidably coupled to the housing part 450. In the present embodiment, the housing part 450 may include an anchor housing 451 and a shoe rotation restriction part 453. The variable length part 430 may be slidably coupled to the anchor housing 451. The shoe rotation restriction part 453 may protrude from either side of the anchor housing 451. According to the rotation of the first or second brake shoe 100 or 200, the other end of the first or second brake shoe 100 or 200 may be placed against the shoe rotation restriction part 453.

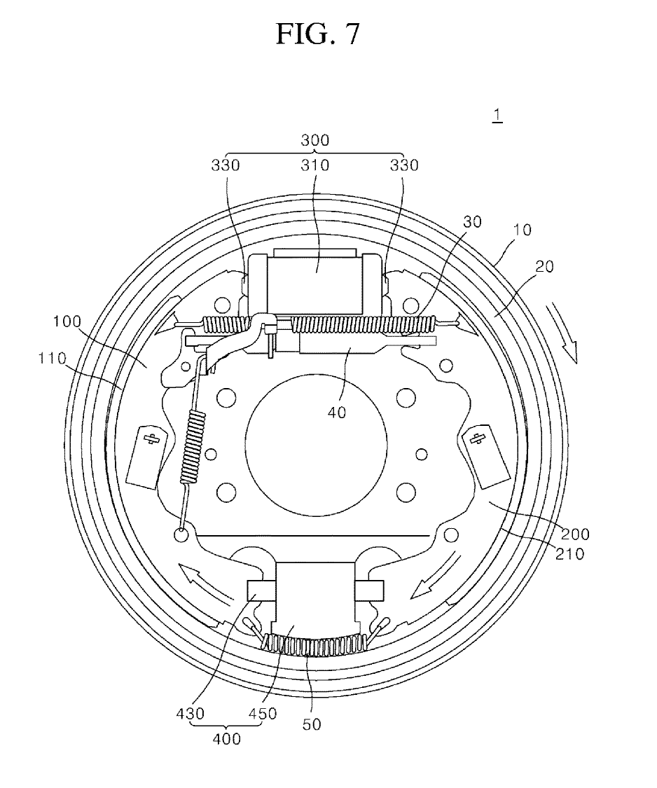

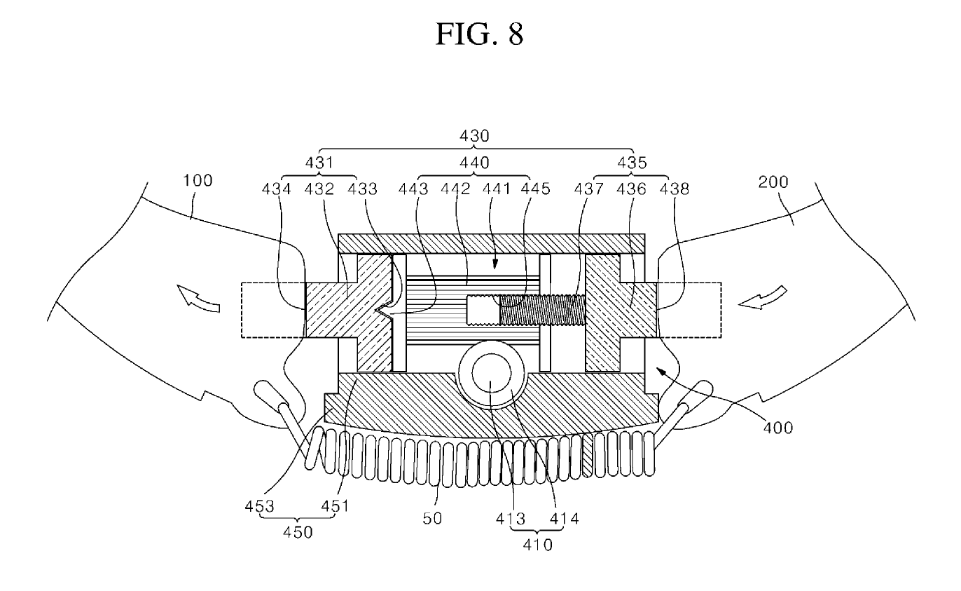

FIG. 7 is a diagram illustrating rotations of the drum and the first and second brake shoes during a parking brake operation of the brake for a vehicle in accordance with the first embodiment of the present invention, and FIG. 8 is a diagram illustrating a state in which the anchor part restricts rotations of the first and second brake shoes in accordance with the first embodiment of the present invention.

Referring to FIGS. 7 and 8, when the drum 20 is rotated by a tilt of the vehicle in a state where the normal brake operation is released or the operation of the wheel cylinder 300 is released, the first and second brake shoes 100 and 200 placed against the drum 20 may be rotated with the drum 20. The rotations of the first and second brake shoes 100 and 200 may be restricted while any one of the other ends of the first and second brakes hoes 100 and 200 is pushed against the housing part 450. As a result, the rotations of the drum 20 and the wheel connected to the drum 20 may be restricted.

At this time, when the other end of any one of the first and second brake shoes 100 and 200 is pushed against the housing part 450, a wedge effect may occur while the other end is caught between the drum 20 and the housing part 450. Then, the frictional force between the drum 20 and the corresponding brake shoe may be further increased to improve the braking force.

As a result, while the length of the variable length part 430 is varied to expand the distance between the other ends of the first and second brake shoes 100 and 200, the anchor part 400 may secure a braking force during an emergency or a parking operation. Furthermore, the anchor part 400 may cause a wedge effect by restricting the rotations of the first and second brake shoes 100 and 200, thereby increasing the braking force.

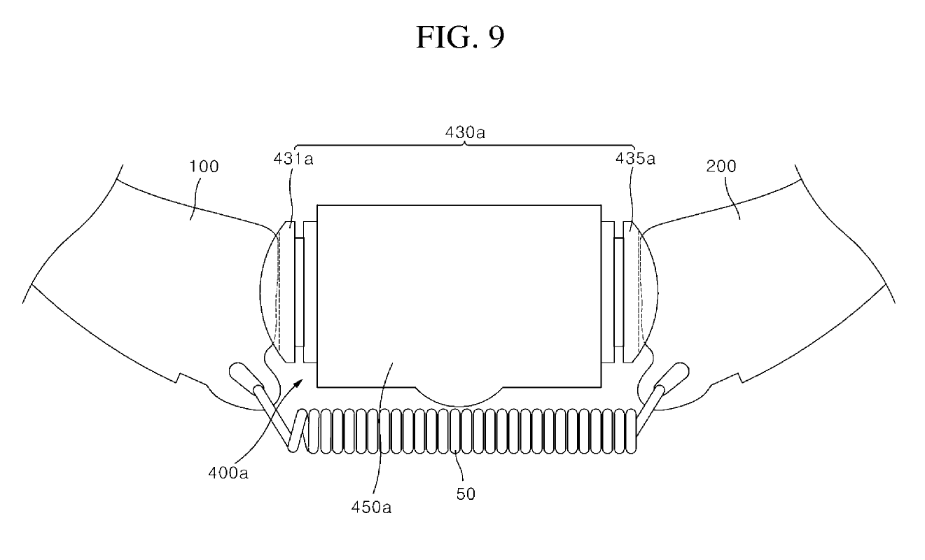

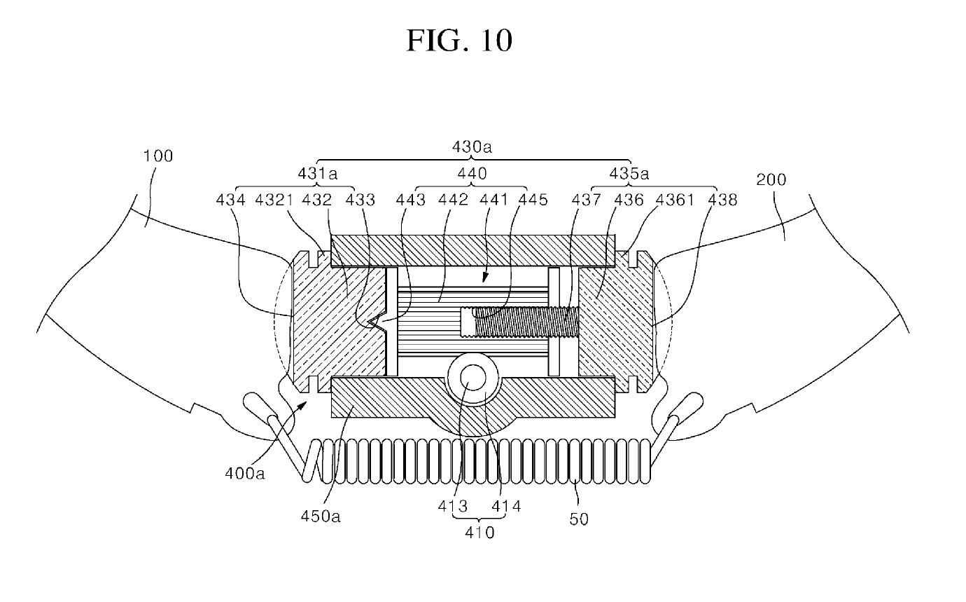

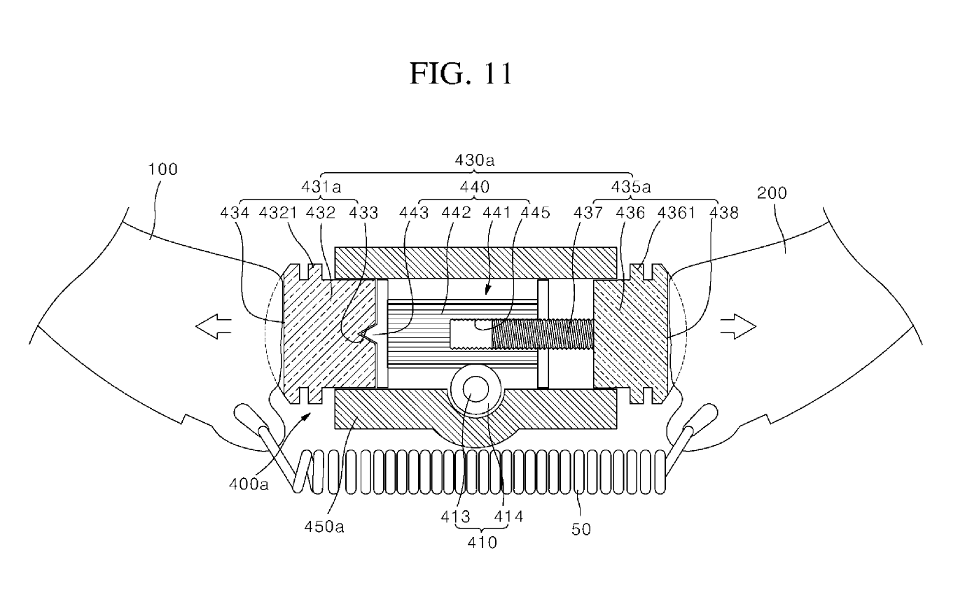

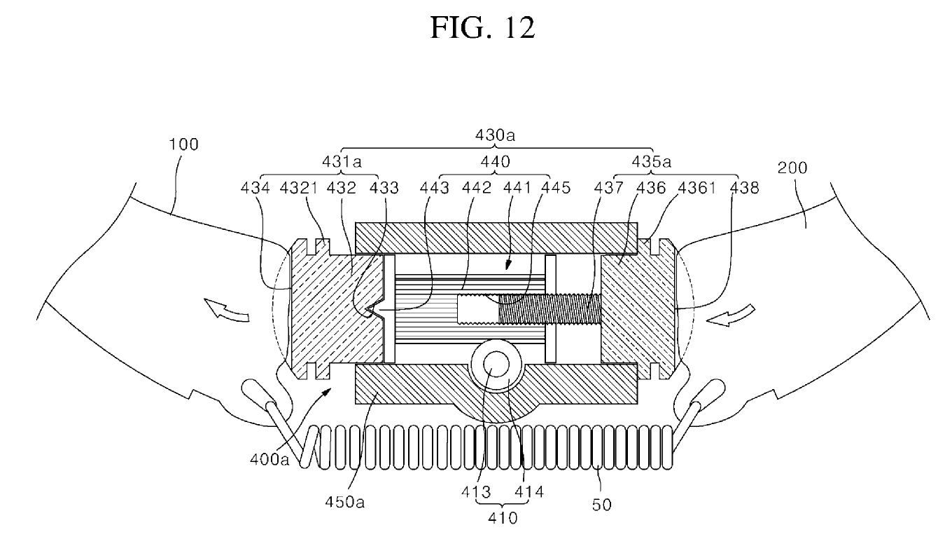

FIG. 9 is a diagram illustrating an anchor part in a brake for a vehicle in accordance with a second embodiment of the present invention, FIG. 10 is a cross-sectional view of the anchor part in the brake for a vehicle in accordance with the second embodiment of the present invention, FIG. 11 is a diagram illustrating a state in which a variable length part is expanded in the anchor part of the brake for a vehicle in accordance with the second embodiment of the present invention, and FIG. 12 is a diagram illustrating a state in which the anchor part restricts rotations of the first and second brake shoes in accordance with the second embodiment of the present invention.

Referring to FIGS. 9 to 12, in the second embodiment of the present invention, the anchor part 400a may expand the distance between the other ends of the first and second brake shoes 100 and 200 while the length of a variable length part 430 is varied. Furthermore, while the moving distance of the variable length part 430a with respect to the housing part 450a is restricted, the anchor part 400a may restrict rotations of the first and second brake shoes 100 and 200, thereby causing a wedge effect.

In the second embodiment, the variable length part 430a may include a first variable part 431a, a second variable part 435a and a variable rotating part 440. As in the first embodiment, the first variable part 431a may include a first body part 432, a first rotation coupling part 433 and a first shoe coupling part 434, and the second variable part 435a may include a second body part 436, a second rotation coupling part 437 and a second shoe coupling part 438.

In the second embodiment, however, the first and second variable parts 431a and 435a of the variable length part 430a may further include first and second bumps 4321 and 4361, respectively.

Specifically, the first variable part 431a may further include the first bump 4321 protruding from the outer circumferential surface of the first body part 432. When the first body part 432 is moved to the inside of the housing part 450a by a preset distance or more, the first bump 4321 may be locked to the housing part 450a so as to limit the extent to which the first body part 432 is inserted into the housing part 450a.

Furthermore, the second variable part 435a may further include the second bump 4361 protruding from the outer circumferential surface of the second body part 436. When the second body part 436 is moved to the inside of the housing part 450a by a preset distance or more, the second bump 4361 may be locked to the housing part 450a so as to limit the extent to which the second body part 436 is inserted into the inside of the housing part 450a.

Thus, since the first and second bumps 4321 and 4361 limit the distance by which the first and second body parts 432 and 436 are moved toward the housing part 450a, the movement of the other ends of the first and second brake shoes 100 and 200 placed against the first and second shoe coupling parts 434 and 438 may be restricted to cause a wedge effect through rotations of the first and second brake shoes 100 and 200 when the vehicle is parked on a slope way.

So far, it has been described that the first and second bumps 4321 and 4361 were applied to the second embodiment of the present invention. However, the first and second bumps 4321 and 4361 can be applied to the first embodiment of the present invention. When the first and second bumps 4321 and 4361 are applied to the first embodiment of the present invention, any one of the first and second bumps 4321 and 4361 may be pushed against the housing part 450 or any one of the other ends of the first and second brake shoes 100 and 200 may be locked to the housing part 450, thereby restricting rotations of the first and second brake shoes 100 and 200.

Hereafter, the operation principle and effect of the brake 1 for a vehicle in accordance with the embodiment of the present invention will be described as follow.

The normal brake operation of the brake 1 for a vehicle in accordance with the embodiment of the present invention may be performed by the wheel cylinder 300. When a normal brake operation signal is generated by a user stepping on the brake pedal, the internal hydraulic pressure of the wheel cylinder 300 may be raised to move the cylinder rods 330 to the outside of the cylinder housing 310.

When the cylinder rods 330 are moved to the outside of the cylinder housing 310, the distance between the ends of the first and second brake shoes 100 and 200 connected to the cylinder rods 330 may be expanded, and the first and second brake shoes 100 and 200 may be expanded to the outside around the other ends placed against the anchor part 400, such that the outer circumferential surfaces thereof are pushed against the internal surface of the drum 20.

Then, while the outer circumferential surfaces of the first and second brake shoes 100 and 200 or specifically the liners 110 and 210 may be pushed against the drum 20, the rotation of the drum 20 may be restricted to generate a normal braking force for restricting the rotation of the wheel coupled to the drum 20.

When a user releases the normal brake operation by stepping off the brake pedal, the internal hydraulic pressure of the wheel cylinder 300 may be lowered. Then, while the first and second brake shoes 100 and 200 are contracted with the cylinder rods 330 by the elastic force of the cylinder spring 30, the first and second brake shoes 100 and 200 may be isolated from the drum 20. The restriction for the rotation of the drum 20 may be released.

The parking brake operation of the brake for a vehicle in accordance with the embodiment of the present invention may be performed by the anchor part 400. When a user generates a parking brake operation signal by pulling the parking brake lever, the motor 411 may be driven to rotate the rotating shaft 413 and the variable rotating part 440.

When the variable rotating part 440 is rotated to release the coupling with the second variable part 435, the distance between the other ends of the first and second brake shoes 100 and 200 may be expanded while the length of the variable length part 430 is expanded.

When the distance between the other ends of the first and second brake shoes 100 and 200 is expanded, the first and second brake shoes 100 and 200 may be rotated about the coupling part with the push rod 40 or the coupling part with the wheel cylinder 300, and pushed against the internal circumferential surface of the drum 20, thereby restricting the rotations of the drum 20 and the vehicle wheels.

In particular, when the vehicle is parked on a slope way, a user may generate a braking force by releasing the normal brake operation in a state where the normal brake operation and the parking brake operation are performed. In this case, when the hydraulic pressure applied to the wheel cylinder 300 is released, the drum 20 may be rotated by an operation of the gravity or the like, and the first and second brake shoes 100 and 200 placed against the drum 20 and the variable length part 430 placed against the other ends of the first and second brake shoes 100 and 200 may be moved with the drum 20.

The movements of the first and second brake shoes 100 and 200 and the variable length part 430 may be restricted while the first and second brake shoes 100 and 200 are pushed against the housing part 450 or the first and second bumps 4321 and 4361 are pushed against the housing part 450a. Furthermore, while the rotations of the first and second brake shoes 100 and 200 are restricted by the housing part 450 or 450a or the first and second bumps 4321 and 4361, the first and second brake shoes 100 and 200 may be caught between the drum 20 and the housing part 450 or 450a, thereby causing a wedge effect to increase the braking force.

When the user releases the parking brake operation by moving the parking brake lever to the initial position, the driving unit 410 may rotate the rotating shaft 413 in the opposite direction of the rotation direction during the parking brake operation. Then, the total length of the variable length part 430 may decrease.

When the total length of the variable length part 430 decreases, the liner 210 may be isolated from the drum 20 while the distance between the other ends of the first and second brake shoes 100 and 200 is reduced by the elastic force of the anchor spring 50. Then, the restriction for the rotation of the drum 20 may be released.

In the brake 1 for a vehicle in accordance with the present embodiment, the anchor part 400 may include the variable length part 430 to expand the distance between the other ends of the first and second brake shoes 100 and 200. Thus, the parking brake force can be realized through a simple structure and operation, even though the brake lever or the like is not applied.

Furthermore, since the variable length part 430 is installed so as to be moved with respect to the housing part 450, the first and second brake shoes 100 and 200 may be rotated to cause a wedge effect, thereby increasing the parking brake force.

In accordance with the embodiments of the present invention, the anchor part of the brake for a vehicle may include the variable length part which is movably installed to expand the distance between the other ends of the brake shoes, and thus secure a sufficient parking brake force through a simple structure and operation.

Furthermore, since the brake shoes are pushed against the drum while the length of the variable length part is varied by the driving unit, the brake for a vehicle can secure a stroke for expanding the brake shoes through a simple operation and structure.

Furthermore, since the variable length part is installed to be moved with respect to the housing part, the brake shoes may be rotated to cause a wedge effect, thereby increasing a parking brake force.

Although embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. A brake for a vehicle, comprising:
first and second brake shoes movably coupled to a back plate, and isolated from each other;
a wheel cylinder positioned between one end of the first brake shoe and one end of the second brake shoe, and configured to expand a distance between the end of the first brake shoe and the end of the second brake shoe; and
an anchor part positioned between the other end of the first brake shoe and the other end of the second brake shoe, and configured to adjust a distance between the other end of the first brake shoe and the other end of the second brake shoe.

2. The brake of claim 1, wherein the anchor part comprises:
a driving unit coupled to the back plate and generating a driving force;
a variable length part having both ends placed against the other end of the first brake shoe and the other end of the second brake shoe, respectively, and adjusting the distance between the other end of the first brake shoe and the other end of the second brake shoe, while the length thereof is varied by the driving unit; and
a housing part coupled to the back plate, and housing the variable length part therein.

3. The brake of claim 2, wherein the variable length part is slidably coupled to the housing part.

4. The brake of claim 2, wherein the variable length part comprises:
a first variable part movably coupled to the housing part, and placed against the other end of the first brake shoe;
a second variable part movably coupled to the housing part, and placed against the other end of the second brake shoe; and
a variable rotating part positioned between the first and second variable parts, and varying a distance between the first and second variable parts while being rotated by the driving unit engaged with the variable rotating part.

5. The brake of claim 4, wherein the driving unit comprises: a motor for generating a rotational force; and a rotating shaft rotated by the motor coupled thereto and having a worm gear formed on the outer circumferential surface thereof, and
the variable rotating part has a groove formed on the outer circumferential surface thereof so as to be engaged with the worm gear.

6. The brake of claim 4, wherein the first variable part comprises:
a first body part slidably coupled to the housing part;
a first rotation coupling part positioned at one end of the first body part, and placed against the variable rotating part; and
a first shoe coupling part positioned at the other end of the first body part, and placed against the first brake shoe.

7. The brake of claim 6, wherein the first rotation coupling part is concavely formed at the end of the first body part, such that the variable rotating part is rotatably fitted to the first rotation coupling part.

8. The brake of claim 6, wherein the first shoe coupling part is concavely formed at the other end of the first body part, such that the other end of the first brake shoe is fitted and coupled to the first shoe coupling part.

9. The brake of claim 6, wherein the first variable part further comprises a first bump protruding from the outer circumferential surface of the first body part, and restricting the extent to which the first body part is inserted into the housing part.

10. The brake of claim 4, wherein the second variable part comprises:
a second body part slidably coupled to the housing part;
a second rotation coupling part positioned at one end of the second body part, and screwed to the variable rotating part; and
a second shoe coupling part positioned at the other end of the second body part, and placed against the second brake shoe.

11. The brake of claim 10, wherein the second rotation coupling part protrudes from the end of the second body part, and is screwed to the variable rotating part through a screw thread formed on the outer circumferential surface thereof.

12. The brake of claim 10, wherein the second shoe coupling part is concavely formed at the other end of the second body part, such that the other end of the second brake shoe is fitted and coupled to the second shoe coupling part.

13. The brake of claim 10, wherein the second variable part further comprises a second bump protruding from the outer circumferential surface of the second body part, and restricting the extent to which the second body part is inserted into the housing part.

14. The brake of claim 4, wherein the variable rotating part comprises:
a rotating body positioned between the first and second variable parts, and rotated by the driving unit engaged with a gear formed on the circumferential surface thereof in the circumferential direction;
a first coupling part which is convexly formed at one end of the rotating body and to which the first variable part is rotatably fitted; and
a second coupling part which is concavely formed at the other end of the rotating body and to which the second variable part is screwed.

15. The brake of claim 2, wherein the housing part comprises:
an anchor housing to which the variable length part is slidably coupled; and
a shoe rotation restriction part which protrudes from both sides of the anchor housing and against which the other end of the first or second brake shoe is pushed according to the rotation of the first or second brake shoe.
